(19) United States
(12) Patent Application Publication
(10) Pub. No.: US 2018/0165301 A1
(43) Pub. Date: Jun. 14, 2018

(54) NESTED FILE MANAGEMENT SYSTEM AND METHOD

(71) Applicant: Hangzhou Dianzi University, Hangzhou City (CN)

(72) Inventors: Jianjun Luo, Los Gatos, CA (US); Hailuan Liu, Hangzhou (CN); Lingyan Fan, Hangzhou City (CN)

(21) Appl. No.: 15/374,937

(22) Filed: Dec. 9, 2016

(51) Int. Cl. G06F 17/30; G06F 3/06

(52) U.S. Cl. CPC G06F 17/30233; G06F 3/0604; G06F 3/0689; G06F 3/0665; G06F 3/0644

(57) ABSTRACT

A method of file management is disclosed for creating a virtual disk on a physical disk partition of a physical disk made of physical storage space. The virtual disk is made of virtual disk files having file system attributes. The method further includes determining a capacity of a storage space for storing a virtual disk file and formatting the virtual disk file with a particular file system format, wherein the virtual disk file has a distinct file system as stored in the physical disk partition. Additionally, the physical storage space of the physical disk is converted into a file system that supports the virtual disk. The virtual disk is configured to save nested virtual disk files, the nested virtual disk files are each configured to store additional nested virtual disk files thereby increasing security of files saved as virtual disk files in the physical disk.

### BACKGROUND

With the rapid development of computer and network technology, growth of data storage has been inevitable and now real. Data storage is commonly employed in the ‘cloud’ in or along with massive networking equipment, such as servers, routers, switches and the like. The cloud continues to gain notoriety for a number of reasons one of which is privacy.

Maintaining security of information traveling through the internet/cloud poses a challenge even in file storage systems readily employed by the cloud. Maintaining information secure is vital in the collection of files with a file name resembling a portion of information (program or data). A file system is a resource that is typically implemented in software, executed by a computer, and includes characteristics such as storing management of information as a part of file configuration, management of such stored files, in addition to being user-friendly.

In file management system architectures a physical storage disk may be divided into multiple partitions that are positioned in parallel relative to each other. The partitions are typically denoted by a letter that specifies a particular file management system storage drive, for example, “C Drive”, “D Drive”, “E Drive” and “F Drive”. Each drive has two types of data, one being files and another being a file system. In this respect, Drive C and Drive D each have corresponding file systems and various files, and so forth. One of the problems with such prior art file management system architectures is the manner in which they store various files—each partition can only support one file system and is managed independently of file systems of the remaining partitions.

Accordingly, document management systems are currently unable to support a variety of file systems on a single disk thereby limiting efficient use of valuable storage space. Additionally and arguably more importantly, the file storage space of conventional methods is at the end node making unauthorized access to sensitive information subject to hacking. A hacker need not to expend great effort and can rather easily crack the contents of a document stored in the files of a file storage system. This is primarily due to the use of a single file system format for each partition in that the hacker need only know of the single file format. The latter issue is clearly undesirable and leaves file information vulnerable interested hackers.

In response to the foregoing deficiencies that currently exist in prior art systems, the need arises for research to provide a solution to and solve the drawbacks of the prior art.

Accordingly, to address these deficiencies, in prior art, there is a need for resolving the foregoing drawbacks currently haunting file management systems.

### SUMMARY

Briefly, a method of file management includes creating a virtual disk on a physical disk partition of a physical disk made of physical storage space. The virtual disk is made of virtual disk files having file system attributes. The method further includes determining a capacity of a storage space for storing a virtual disk file and formatting the virtual disk file with a particular file system format, wherein the virtual disk file has a distinct file system as stored in the physical disk partition. Additionally, the physical storage space of the physical disk is converted into a file system that supports the virtual disk. The virtual disk is configured to save nested virtual disk files, the nested virtual disk files are each configured to store additional nested virtual disk files thereby increasing security of files saved as virtual disk files in the physical disk.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a two-dimensional linear diagram of a nested file management system 100, in accordance with an embodiment of the invention.

FIG. 2 shows a computer system 200, as an exemplary application of the virtual disk drive 108.

FIG. 3 shows two examples of drives, disk drive 302 and solid state disk drive 304, either one of which may include the system 108. FIG. 4 shows a diagram of a nested file system 400, in accordance with an exemplary embodiment of the invention.

FIG. 5 shows another example of a disk drive including an embodiment of the invention.

FIG. 6 shows a high-level diagram of the relevant portion of one of the file systems, such as File System1 102, in accordance with an embodiment of the invention. FIG. 7 shows a block diagram of further details of the virtual disk explorer 600 of FIG. 6.

FIG. 8 shows an exemplary disk drive system 800, in accordance with an embodiment of the invention.

FIG. 9 shows a conceptual diagram of a disk space 900 within the context of the virtual disk spaces of the embodiments of the invention.

FIG. 10 shows a flow chart of some of the steps performed by one or more processors within the computer system housing the disk drive C: 900 of FIG. 9 with virtual files.

### DETAILED DESCRIPTION OF EMBODIMENTS

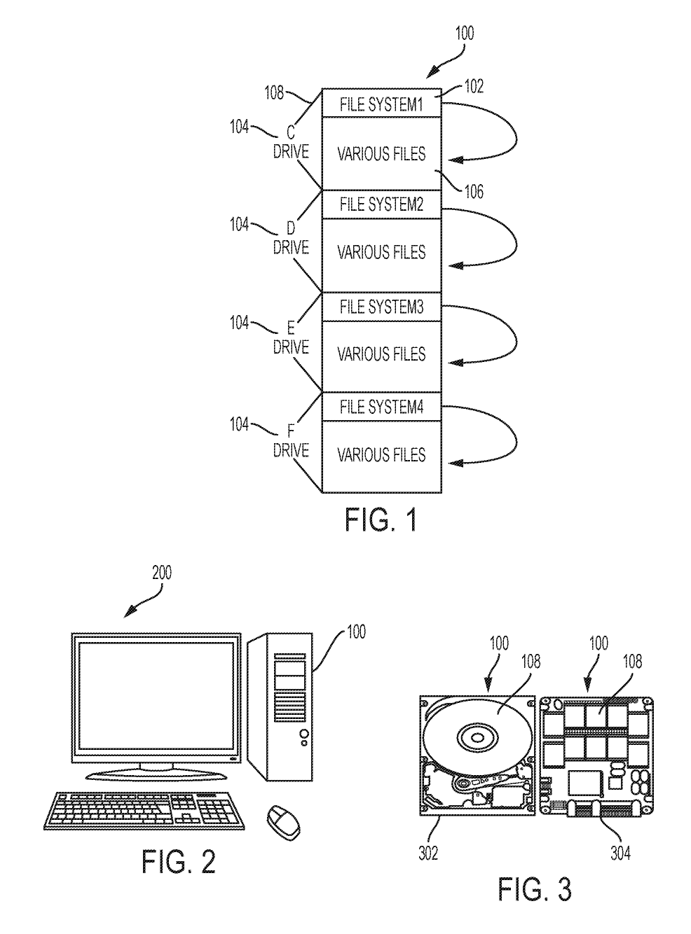

FIG. 1 shows a two-dimensional linear diagram of a nested file management system 100, in accordance with an embodiment of the invention. The system 100 is shown to include a partitions of a virtual disk drive 108 (also referred to herein as “virtual disk partitions”). The partitions are shown as partitions of a virtual disk drive 104, which is shown to include Disk Drive C, Disk Drive D, Disk Drive E and Disk Drive F, a total of four disk drives. It is noted that while the embodiment of FIG. 1 shows four disk drives, any other number of drives may be employed.

Each disk drive is shown to include a file system and files. For example, Disk Drive C is shown to house various files 106 and File System 1 102 and so on. A file system of a disk drive has information about the files the disk drive includes. For instance, the File System 1 102 has information regarding the files 106 of Disk Drive C and so on. The file system includes information such as, without limitation, attributes about the file, file format, perhaps the sizes of the files and other relevant file information.

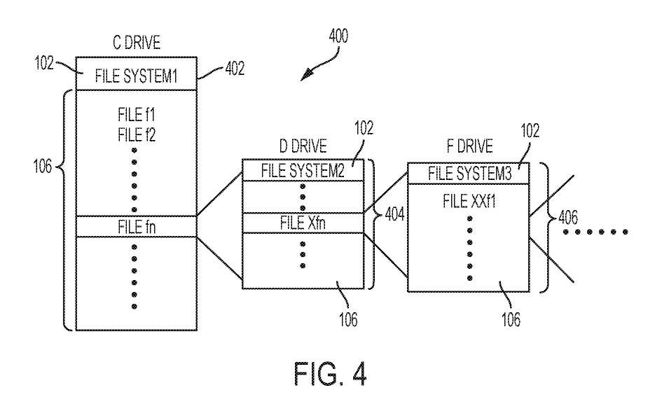

The virtual disk drive 108 generally reflects the files that a user or the system stores or would store in a physical disk drive. To this end, FIG. 2 shows a computer system 200, as an exemplary application of the virtual disk drive 108. As commonly known, the computer system 200 includes a disk drive, normally a physical disk drive. An embodiment of the invention with the computer system 200 houses the virtual disk drive 108 as a part of its system 100. FIG. 3 shows two examples of drives, disk drive 302 and solid state disk drive 304, either one of which may include the system 108. Alternatively, a computer system or any other system requiring storage, such as networking equipment, may have more than one disk drive partially or entirely made of virtual disk space.

As will be further evident shortly, each of the disk drives of the embodiment of FIG. 1 is treated as a distinct drive, in a virtual sense. Stated differently, the operating system of the computer system 200, for instance, regards each of the virtual disk drive 104 as a separate disk drive. In this respect, files of disk drives can be nested or embedded within one another making it very difficult for a potential intruder to invade the contents of files. “Virtual files” and “virtual disk files” as used herein are synonymous.

FIG. 4 shows a diagram of a nested file system 400, in accordance with an exemplary embodiment of the invention. The embodiment of FIG. 4 shows part of the virtual disk drive 108 of FIG. 1 in a conceptual form that shows virtual disk drive 108, as nested file system 400, perhaps conceptually closer to the arrangement of the disk drives.

As shown in FIG. 4, Disk Drive C includes File System 1 102 and Files 106, which are shown made of File fl through and past File fn, thus including at least ‘n’ files, ‘n’ being an integer value.

File G is shown to make up its own disk drive, i.e. Disk Drive D, also made of a file system and files, i.e. files Xf₁ through and past File Xfₙ, therefore including at least ‘n’ number of files. File Xfₙ is shown to be its own independent disk drive, i.e. Disk Drive F, which also includes a file system and files, File System 3 and File SSf₁ through File XXfₙ, respectively. There may be yet additional disk drives, each distinct from the other and including its own file system.

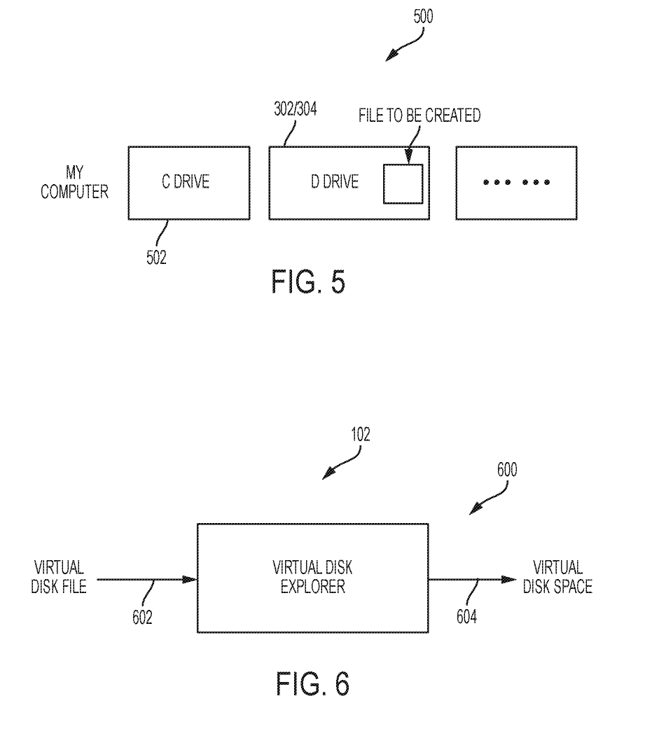

FIG. 5 shows another example of a disk drive including an embodiment of the invention. In FIG. 5, an exemplary disk drive arrangement 500 includes a physical disk drive, Disk Drive C and a virtual disk drive, Disk Drive D, which may be disk drive 302/304. Disk Drive D is shown to house the files to be created, much like the files 106 of FIG. 1. Additional disk drives are optionally included in the disk drive arrangement 500.

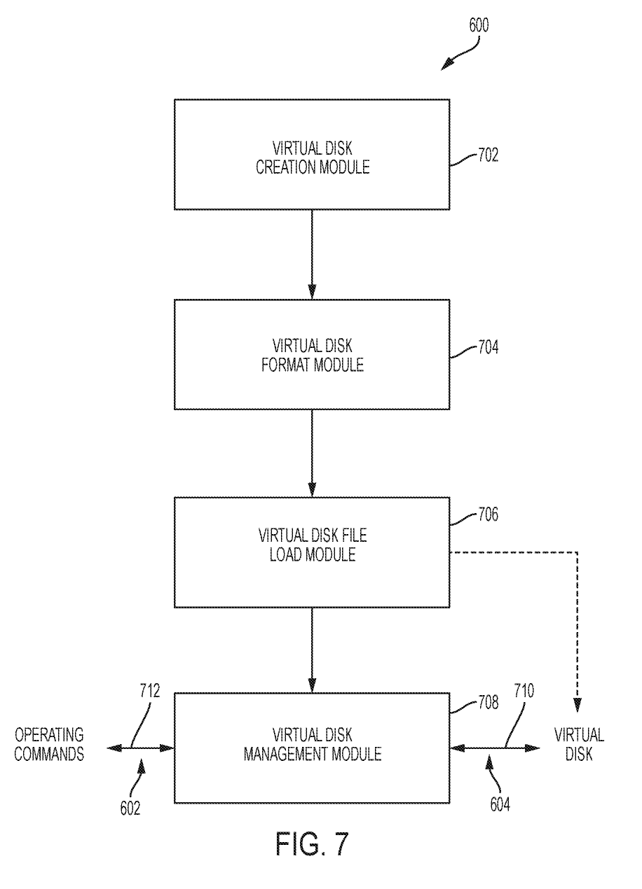

FIG. 6 shows a high-level diagram of the relevant portion of one of the file systems, such as File System1 102, in accordance with an embodiment of the invention. The File System 1 102 is shown to include a virtual disk explorer 600 that is shown to receive a virtual disk file 602 and output virtual disk space 604. The virtual disk explorer 600 receives files to be stored in a system of which the File System 1 102 is a part. These files are typical files in a system, such as a computer system, saved by a user or the system itself. They are saved in arrangements such as the various embodiments of the invention as nested virtual files, an example of which is shown in FIG. 4. The virtual disk explorer 600 saves the attributes of the in-coming files, possibly converts their format, assigns a virtual storage space in the virtual disk drive that houses the disk explorer 600 and performs any other requisite housekeeping tasks.

In an embodiment of the invention, the virtual disk explorer 600 can be an executable program, which can perform a file creation operation via the file (or disk) creation module 702 and afterward, perform file format operation via the file (or disk) format module 704, and load the file created by the file creation module 702 via the file (or disk) load module 706, and perform file management operations via file (or disk) operations module 708.

When creating a file, first the file name is set, and file extension name and file space are also defined, then the system generates the file according to above setting. The user can directly see the file name and file extension (such as “.doc” or “.pdf”) on the user's monitor. Meanwhile, the user cannot directly manipulate the file without loading the nested file management system on its monitor. Only after loading the file via file load module, could the virtual disk space display normally and could the user could perform corresponding file management operations.

Among them, the file operation module provides users with the interface for manipulating files through which the system receives operation instruction from users. File management operation generally includes file view, copy, cut, paste, and delete operations.

There is no distinction between the routine disks and the virtual disk formed from the virtual disk file of the various embodiments of the invention. For example, a user can view, create, modify, copy, paste, cut or delete files. Also, the user can check all of the file attributes, including file name, file type, creation time, file size, and the like on its screen.

The file above is virtualized as a disk space. While shown as a file with an appropriate extension name, the true file type is stored in the file information independent of the extension name displayed on the user's monitor. For example, a file with a ‘.doc’ extension name may not be any document file and is rather an executable file or another type of file. Therefore, hackers or information thefts are unable to directly access the file information which greatly enhances the file information security.

FIG. 7 shows a block diagram of further details of the virtual disk explorer 600 of FIG. 6. The virtual disk explorer 600 is shown to include virtual disk creation module 702, virtual disk format module 704, virtual disk file load module 706, and virtual disk management module 708. Virtual disk management module 708 is shown to receive operating commands 712, which is a part of the virtual disk file 602 and outputs virtual disk 710, which is a part of the virtual disk space 604. Operating commands are commands from the host of a computer system or other systems employing various embodiments of the invention. These commands include commands to save, read, or write files to the disk.

The virtual creation module 702 creates the disk drive in which files are to be saved. An example of this disk drive is C drive 402 or any one of the virtual disk drive 104 in FIG. 1. Next, the virtual disk format module 704 formats the file or to be more specific, the file format portion of the file. Thereafter, the virtual disk file load module 706 loads the created disk drive with the file and after than, the virtual management module 708 manages the disk drive in which the file has been saved. The dashed arrow shown in FIG. 7, shows the path of the file that is to be loaded in the created disk drive. This is the path, virtual disk 710, files would take when being stored in the created disk drive. The management of disk drive, after its creation, is performed by the module 708 and at times, is performed at substantially the same time the file is being saved in the created disk drive. “Disk drive” and “disk” are used synonymously herein.

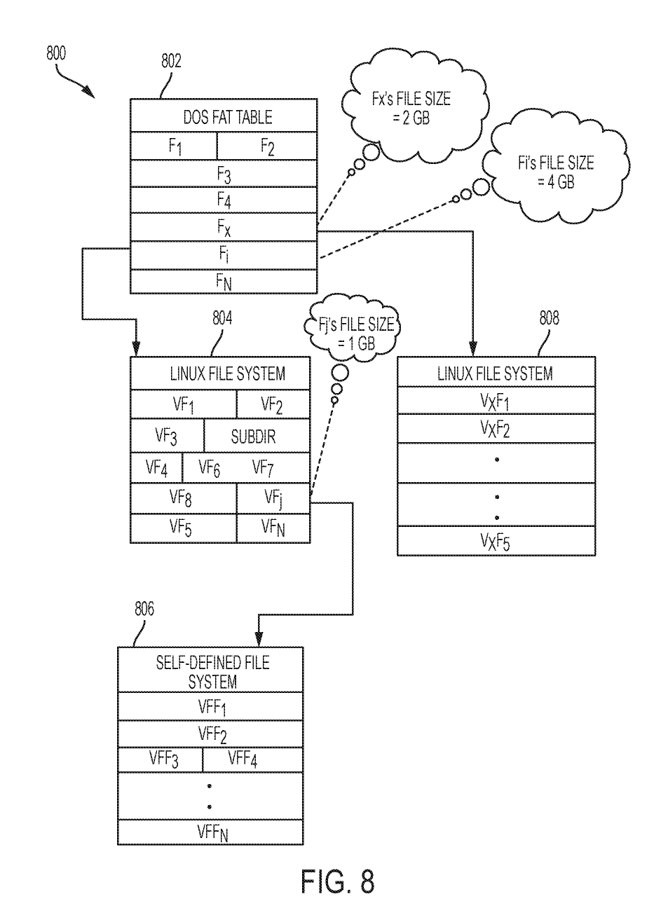

FIG. 8 shows an exemplary disk drive system 800, in accordance with an embodiment of the invention. In the example of FIG. 8, a disk drive 802 has a capacity of 64 gigabytes (GBytes), of a C drive. Thus, the disk drive 802 is a Disk Drive C. The disk drive 802 includes a File Allocation Table (FAT) table for a Disk Operating System (DOS) operating system.

The disk drive 802 is shown to include various files, i.e. F1 through F_{N}, including Fₓ and Fᵢ, ‘N’ being an integer value. The Fᵢ file in the disk drive 802 points to another disk drive, namely disk drive 804, which may be, for instance, Disk Drive D. The disk drive 804 similarly includes files, i.e. VF1 through VFN including VFi. File VFi also points to another disk drive, i.e. disk drive 806, which includes files VFF1 through VFFN. As such, the files saved in the disk drives 802-806 are nested files.

The disk drive 806 may be Disk Drive E. The file Fx in disk drive 802 is shown to have a capacity of 2 Gbytes while the file Fi is shown to have a capacity of 4 Gbytes. In fact, each file in each of the disk drives of FIG. 8 may have a distinct file size. The file size of the file VFj in the disk drive 804 is shown to be 1 Gbytes.

As commonly known, an operating system imposes its distinct file format. Therefore, the format of the files in the disk drive 802 is different than that of the disk drive 804, the files of these two operating systems are accordingly not compatible. As such, not all of the files of disk drive system 800 are nested within various drives. For example, disk drive 808, which may be, for instance Disk Drive F:, has files VxF1-VxF5, none of which point to files of other disk drives.

Each of the disk drives 804-808 is created by the module 702 of FIG. 7 and each has its own “sub-directory”, such as is shown in disk drive 804. The sub-directory may be viewed as the file system of the C, D, and E disk drives of FIG. 8. Each of the files of the disk drives 804-808 has a distinct file format that may or may not be the same as the file format of another disk drive. As previously noted for example, the format of the files in the disk drive 804 uses Linux whereas that of the disk drive 802 uses DOS. The module 704 of FIG. 7 converts one format to another thereby making all disk drives file-format compatible. It should be noted that each of the disk drives 802-808 has its own virtual disk explorer 600.

The disk drives 804 and 808 have a different operating system than that of the disk drive 802. The disk drive 804 uses the Linux operating system while the disk drive 802, as earlier noted, uses DOS. The module 704 of each of the created disk drives ensure format-compatibility between the files of different operating systems.

The disk drive 802 is a FAT table, as would normally be used by conventional disk drives, is a table that an operating system maintains physically on a hard disk that provides a map of basic units of logical storage on a hard disk that a file has been stored in. Accordingly, each of the files F1-FN provides logical storage on the hard disk where a file is stored. For example, file F3 might have logical storage information about where the file VF2 is, in logical storage units, in the hard disk drive. Instead, the embodiments of the invention use this information to point to a location in a virtual disk drive where the file is saved in, such as the disk drive 804 or 806. This does not mean that the physical file space does not exist, the virtual e space of the embodiments of the invention may in fact reside on the same physical disk drive or on a different disk drive.

The disk drive 806 is a self-defined file system allowing a user of the disk drive system 800 to define its own operating system.

In the disk drive 802 of FIG. 8, an example of the FAT table is for a FAT32 file system. Using the FAT32 file system, an example is discussed about the process of the file format operation of the various embodiments of the invention.

After formatting the created disk drive using file management application under formation prescribed by the FAT32 file system, a file layout is created, with various file-related data in the following sequence, the DBR area, FAT area, the root directory area and data area. DBR (DOS Boot Recorder—DOS Boot Record) is total 512 bytes, with the end of “55 AA” Bytes, recording the start address, the end address, the space size, the FAT tables number, and the number of sectors per cluster of the file system, and so on. FAT (File Allocation Table, File Allocation Table) is a table used to record the file location, which is significantly important for file access, and if lost, the data stored on the disk would not been accessed due to inability to locate, so there are two FAT tables in FAT32 file system, FAT1 and FAT2 which is the former backup, and FAT2 stored by FAT1; The root directory area follow by FAT2 table, which records the file name, attributes, created time, last accessed time, start addresses, file size and other information of each file in the root directory (created using the above procedure); The user data area is used to store user data. DBR area, FAT area and root directory area only occupies a small part of the space.

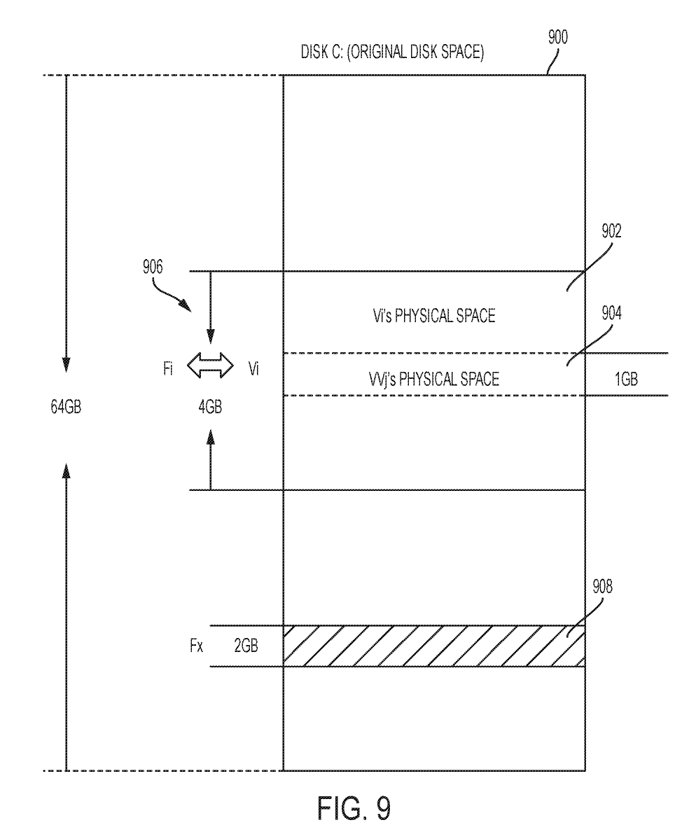

FIG. 9 shows a conceptual diagram of a disk space 900 within the context of the virtual disk spaces of the embodiments of the invention. That is, the physical disk drive space is configured to store the virtual files of the various embodiments of the invention. The physical disk drive is generally the Disk Drive C:, such as the disk drive 802 of FIG. 8. Thus, the Disk Drive C: 900 has a capacity of 64G-bytes (or GB) and is configured into disk space partitions for housing virtual disk drives with their files. For example, the physical space 902, which is a 4 GB space, is reserved for the Vi files, i.e. the files of the disk drive 804, and the physical space 904 of the disk drive C: 900 is designated to house the files of the disk space 806. The physical space 908 is configured to save the files of the disk space 808. Accordingly, the virtual files of the physical space 904 are nested or embedded within the virtual files of the physical space 902. Accordingly, unauthorized access to the virtual files of the space 904 and the virtual files within the physical space 904, if any, is made increasingly difficult. Additionally, as previously noted, the file format of the virtual files of physical space 904 may be different than those of the physical space 902 but because of the capability of file format conversion, shown at 906 in FIG. 9, files of various operating systems may be seamlessly save within the disk drive C: 900. The disk drive C: 900 of FIG. 9 may be the disk drive 302 or 304 of FIG. 3.

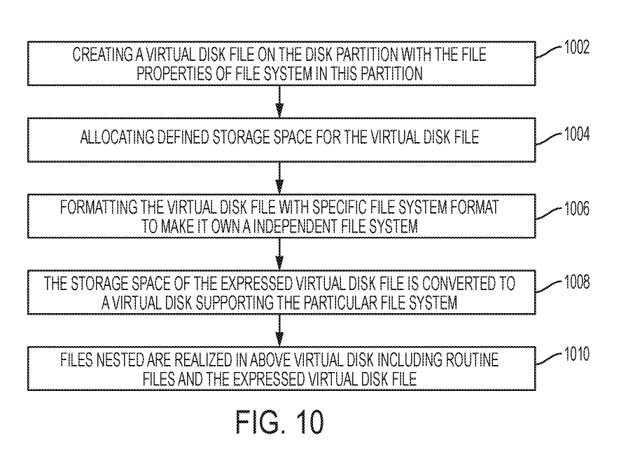

FIG. 10 shows a flow chart of some of the steps performed by one or more processors within the computer system housing the disk drive C: 900 of FIG. 9 with virtual files. For instance, the computer system 200 of FIG. 2 have such processors. In FIG. 10, at step 1002, a virtual disk space with virtual files is created on the disk drive C: 900 (of FIG. 9) using the FAT table in the disk drive 802, which may itself be a part of the disk drive C: 900. The physical spaces 902 and 904 are examples of partitions. The properties of the virtual files saved in these partitions are adjusted or converted to the file properties of the space within which these files are saved.

Next, at step 1004, physical space is allocated for the virtual disk space, for example, the 4 GB physical space 902, shown in FIG. 9. Next, at step 1006, the virtual disk file is formatted with the specific file system format to make it own an independent file system, such as that of the disk drive 806. Subsequently, at step 1008, the storage space of the expressed (or specified) virtual disk file is converted to a virtual disk supporting the particular file system by the module 704. Next, at step 1010, the nested virtual files are realized by the virtual disk drive including ordinary files or routines and the expressed virtual disk file.

Steps 1002 through 1010 are described in further detail below.

Step 1002: creating a virtual disk file on a physical disk partition, which has the same file attributes as the routine file in partition file system. The disk partition can be PC hard drives, removable hard disk or U disk, and the physical disk can be the memory in PC, PAD or portable terminals;

Step 1004: allocating certain storage capacity for the virtual disk file;

Step 1006: formatting the virtual disk file in a preset file system, making sure that the virtual disk file on the partition has a separate file system, and the preset file system can be any one of FAT16, FAT32, NTFS, EXT2 and EXT3, but it is not limited to this, for example, it may be a file management system of the customer-defined.

Step 1008: the storage space of the virtual disk file transformed into a virtual disk supporting the particular file system, and this procedure is compatible with different file system format.

Step 1010: transforming the virtual disk file into a virtual disk file to perform file management operation, and nest stored regular files or the virtual disk files above in the virtual disk.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for dynamic templates for virtualized systems.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

The description of the above embodiment is only used to help understanding the method and core idea of this invention. It should be noted that we can also do several improvements or modifications on this invention without departing from the principle of this invention for those ordinary technicians in this technology field, and any improvement or modification also fall within the protected scope of the invention claimed.

The previous description of the disclosed embodiment will help technicians in the field to realize or use the invention. These various modifications about the embodiment will be apparent for those technicians in the field, and the general principle defined this document may be realized in other embodiment without departing from the spirit or scope of this invention. So this invention conforms the widest range which is consistent with the principle and novel features disclosed in the document, rather than limited in these embodiments expressed herein.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

What we claim is:

1. A method of file management comprising:
creating a virtual disk on a physical disk partition of a physical disk made of physical storage space, the virtual disk made of virtual disk files having file system attributes;
determining a capacity of a storage space for storing a virtual disk file;
formatting the virtual disk file with a particular file system format, wherein the virtual disk file has a distinct file system as stored in the physical disk partition; and
converting the physical storage space of the physical disk into a file system that supports the virtual disk, the virtual disk being configured to save nested virtual disk files, the nested virtual disk files each configured to store additional nested virtual disk files thereby increasing security of files saved as virtual disk files in the physical disk.

2. The method of claim 1, wherein the virtual disk files have various file attributes corresponding to a specific file system.

3. The method of claim 1, wherein the size of the virtual disk is used to determine the capacity of the physical disk.

4. The method of claim 1, further including creating a plurality of virtual disks having stored therein sub-directories for pointing to a virtual file in another virtual disk.

5. The method of claim 1, further including creating a virtual disk, formatting virtual disk files of the virtual disk, loading the formatted virtual disk files and performing file operations on the formatted virtual disk files.

6. The method of claim 1, wherein the physical disk partition is a part of a personal computer (PC), hard disk, mobile hard disk or formed in the U disk partition.

7. The method of claim 1, wherein the virtual disk file system format is FAT16, FAT32, NTFS, EXT2, or EXT3.

8. The method of claim 1, wherein file management operations include view, build, copy, cut, paste and delete.
